(19) United States
(12) Patent Application Publication
(10) Pub. No.: US 2015/0273604 A1
(43) Pub. Date: Oct. 1, 2015

(54) MATERIAL JOINING INSPECTION AND REPAIR

(71) Applicant: COMAU LLC, Southfield, MI (US)

(72) Inventors: Mark Anderson, Southfield, MI (US); John Forrest, Southfield, MI (US); He Wang, Southfield, MI (US)

(21) Appl. No.: 14/665,209

(22) Filed: Mar. 23, 2015

Related U.S. Application Data
(60) Provisional application No. 61/970,087, filed on Mar. 25, 2014.

(51) Int. Cl. B23K 1/14; B23K 31/02

(52) U.S. Cl. CPC B23K 1/14; B23K 31/02

(57) ABSTRACT

Methods and apparatuses for joining or sealing two workpieces together are described herein that automatically detect and record positions along a material joining or sealing path where the finished joint is unacceptable. While the joint is being formed, a sensor can scan the joint to determine joint quality based on surface geometry of the joint. If portions are determined to be unacceptable based upon surface geometry, the positions along the joining path are recorded into memory and an inspection and/or repair path is generated and selectively executed to inspect and/or repair the detected fault in the joint.

### CROSS-REFERENCE TO RELATED APPLICATION

This application claims priority benefit to U.S. Provisional Patent Application Ser. No. 61/970,087, filed Mar. 25, 2014 which is incorporated by reference in its entirety.

### TECHNICAL FIELD

The field of disclosure generally pertains to material joining and sealing processes. The invention is particularly useful in material joint fabrication, inspection and repair.

### BACKGROUND

Brazing and welding are examples of processes used to fuse or join two or more closely positioned pieces of material together. In common brazing and welding processes a filler material is melted to at least partially fill the gap or void between the components. Various heating methods for melting the filler material can be utilized, including the use of lasers. In the automotive field, laser brazing is commonly used to connect exterior body panels and provide a smooth joint appearance, while protecting the anti-corrosive properties of the components.

Various material joining or sealing processes, including brazing, can result in imperfections or gaps in the desired continuous seam weld, seal or brazed area that can affect the aesthetics and/or performance characteristics of the joint. Conventional seam welding and brazing processes have suffered from many disadvantages including difficulties in identifying where along a brazing line a problem or substandard seam may have occurred. For example, conventional brazing systems can identify that a fault or potential defect has occurred, but there is no, or minimal, tracking or monitoring device to specifically identify where the fault occurred. As a result, convention processes often have to remove the vehicle from the line for manual inspection and then initiate a repair process before reinserting the vehicle back into the assembly process. These disadvantages are time consuming, costly and logistically challenging for high volume assembly facilities.

There is a need for a device and process which actively monitors the quality of a joining process, for example seam welding or a brazing line. When a seam defect is detected, the system can accurately identify where the problem occurred, so an automated inspection and/or repair process, for example automatic re-welding or re-brazing, of the problem area can take place.

### SUMMARY

Disclosed herein are exemplary embodiments of various devices and methods for automatically detecting and recording positions along a material joining path where imperfections in the finished joint may have occurred for automated repair.

In one example, a method for joining or sealing a first workpiece and a second workpiece is disclosed. The method includes positioning a filling or joining head in alignment with a joint between the first and second workpieces along a predetermined joining path. The head can be selectively moved along a joint path of travel defined by the joint, and joint filler material can be sequentially added along the joint path of travel. The method further includes measuring a surface geometry of the filled joint while the joining head moves along the joint path of travel, and identifying at least one characteristic in the surface geometry. The geometric coordinate position of the joint, defect and/or joining head can be stored in memory. For instance, if a fault or defect is detected, the position of the defect or fault is automatically identified and recorded. A repair path can be generated that includes the positions of the joining path where the fault was detected. In one example, the process automatically returns the device to the site of the defect to make repairs. In these methods, it is possible to repair a section quickly and accurately, without the need for manual intervention.

In one example, a sensor connected to the automated device scans the workpiece and detects surface geometry of the fill material. The device identifies fault portions of the joining path based on the surface geometry of the fill material and generates a repair joining path based on the positions of the identified fault portions.

In another example, the device and method further senses braze joint quality along the joining path by projecting a line of light across the workpiece at the location including the joining path and detecting the contour of the line of light, wherein joint quality is measured by the contour and identifying and recording portions of the joining path where joint quality is unacceptable. A repair path is generated that includes the positions of the joining path where joint quality is unacceptable, and the joining path can be repaired by adding filling material between the first workpiece and the second workpiece along the repair path.

Variations in these and other aspects, features, elements, implementations, and embodiments of the methods, systems, and devices are disclosed herein will be recognized by those skilled in the art on reviewing the following descriptions and illustrations hereafter.

### BRIEF DESCRIPTION OF THE DRAWINGS

The description herein makes reference to the accompanying drawings wherein like reference numerals refer to like parts throughout the several views, and wherein:

FIG. 1 is a perspective view of an exemplary joining system in operation;

FIG. 2 is a perspective view of an example of a joining system with an exemplary sensor;

FIG. 3 is a block diagram showing an example of a hardware configuration for a controller for use with one or more examples of the invention;

FIG. 4 is a schematic illustration of an exemplary sensor measuring range;

FIGS. 5A and 5B are sectional views of a joint illustrating exemplary sensor measuring ranges;

FIGS. 6A and 6B are graphical views of exemplary measurements obtained from a sensor used with one example of the invention;

FIG. 7 is a side view of the joining system of FIG. 2 in an exemplary application along a joining path of a vehicle roofline;

FIG. 8A is a side view of the joining system of FIG. 2 used along an exemplary repair path;

FIG. 8B is an enlarged view of a portion of the repair path of FIG. 8A;

FIG. 9 is a flow diagram of an exemplary process for inspecting and repairing a joint;

FIG. 10 is a perspective view of an example of a joining system having a sensor connected via a swivel; and

FIG. 11 is a front view of the joining system of FIG. 10.

### DETAILED DESCRIPTION OF EMBODIMENTS OF THE INVENTION

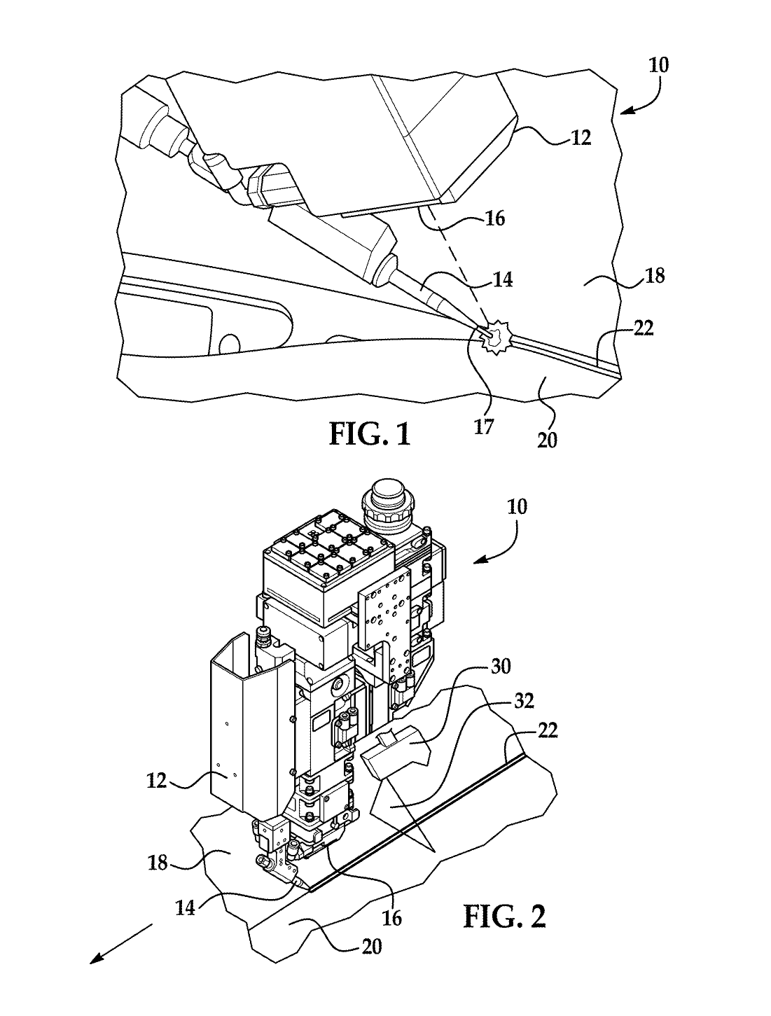

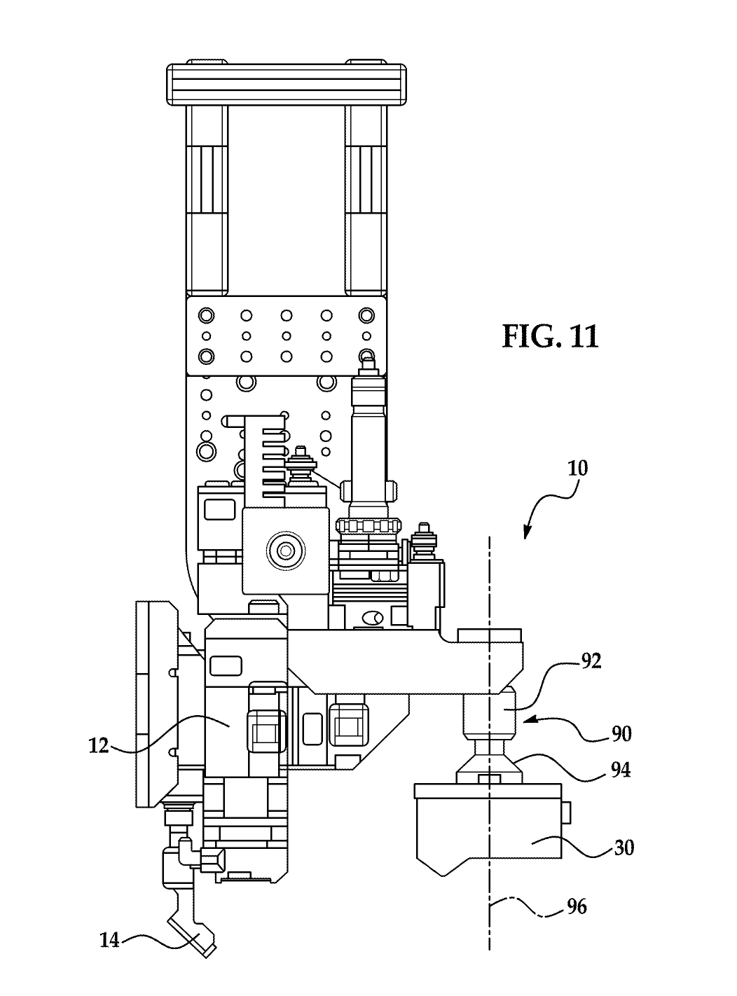

Referring to FIGS. 1-11, examples of devices and methods for material joining, sealing, inspection and/or repair are illustrated. Referring to FIGS. 1 and 2, an exemplary welding/brazing system 10 is shown. In the example, a filling, joining or sealing head or end effector 12 (generally referred to as a joining or end effector head or 12 for convenience only) is connected to an industrial multi-axis programmable robot for movement along a preprogrammed and predetermined path of travel. In the example shown, the joining head 12 is a laser welding/brazing end effector head 12 and includes a fill material feeder 14 and a laser 16. The feeder 14 operates to deliver a filler material, for example a feed wire, to an area where the filler material can be heated and at least partially melted by the laser 16. As used herein, the term “laser” can include any device capable of locally heating fill material near feeder 14. The filler material can be deposited between a first workpiece 18 and a second workpiece 20 to create a joint 22. A variety of metals can be employed as fill material depending on the particular application and material properties of the first and second workpieces 18 and 20. It is understood that different heads, filler feed devices and heating devices suitable for seam welding, brazing, sealing or filling operations known by those skilled in the art may be used. It is further understood that the invention may be useful in other applications than seam joining applications, for example welding or brazing where two metal components form a joint and need to be connected and at least partially filled. For example, the invention 10 may be used for adhesive or sealing lines where a line or bead of sealant, adhesives or other materials are applied to a joint or seam. Although generally discussed as a preferred brazing or seam welding system, system 10 may be used in other applications and on other structures as known by those skilled in the art.

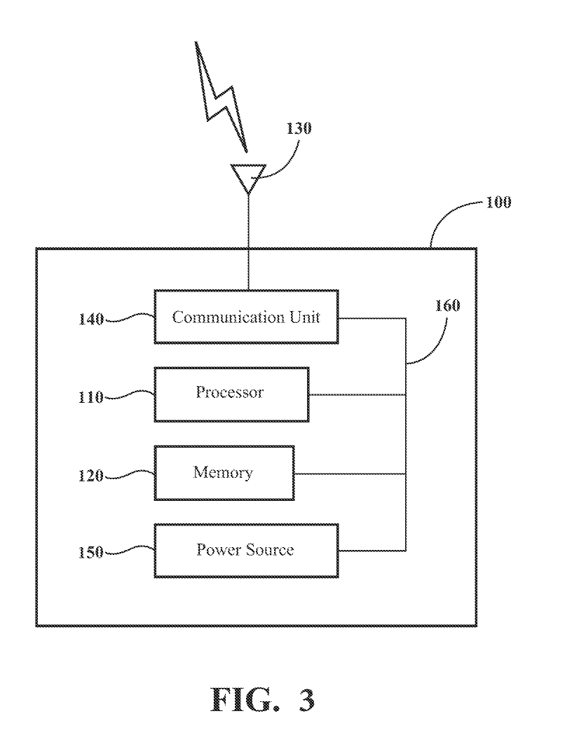

In the exemplary system 10, a controller 100 is used to implement and control the predetermined operations of the system 10. FIG. 3 is a diagram of an example of a portion of the controller 100 in which the aspects, features, and elements disclosed herein can be implemented. The exemplary controller 100 includes a processor 110, a memory 120, an electronic communication interface 130, an electronic communication unit 140, a power source 150, and a communication bus 160. The controller 100 may communicate data and other signals to and from other controllers or devices, or to a central communication device in the facility, through communication cables (not shown) or wirelessly through wireless communication protocols used in the industry and as known by those skilled in the art. Although shown as a single unit, any one or more elements of the controller 100 can be integrated into any number of separate physical units. Additional subcomponents, combinations of subcomponents and interconnections between subcomponents known by those skilled in the art may be used depending on the application or performance specifications.

In one example, the controller 100 is connected to the filler head 12 and/or the robot. Alternatively, the controller 100 can be located elsewhere, such as in the assembly facility or in a computing “cloud” and communicate the operation signals to the head 12 for execution. One example of a cloud-based communication system is U.S. Published patent application Ser. No. 12/725,635 filed Mar. 17, 2010 and is incorporated herein by reference.

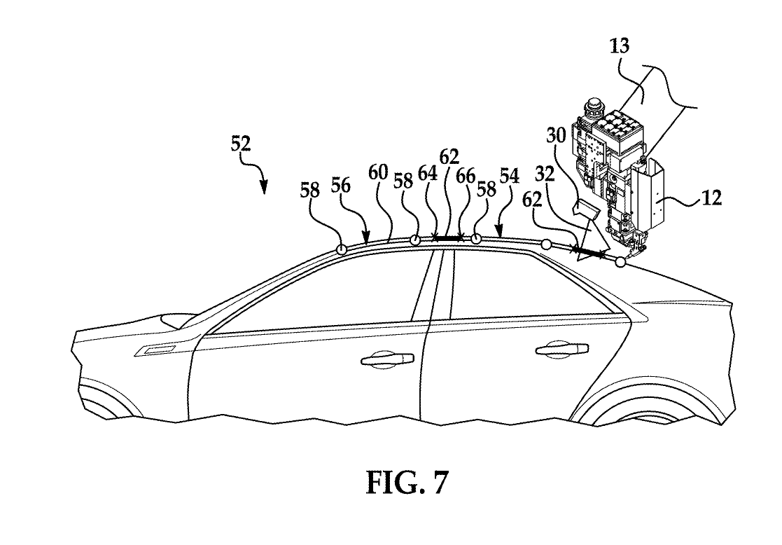

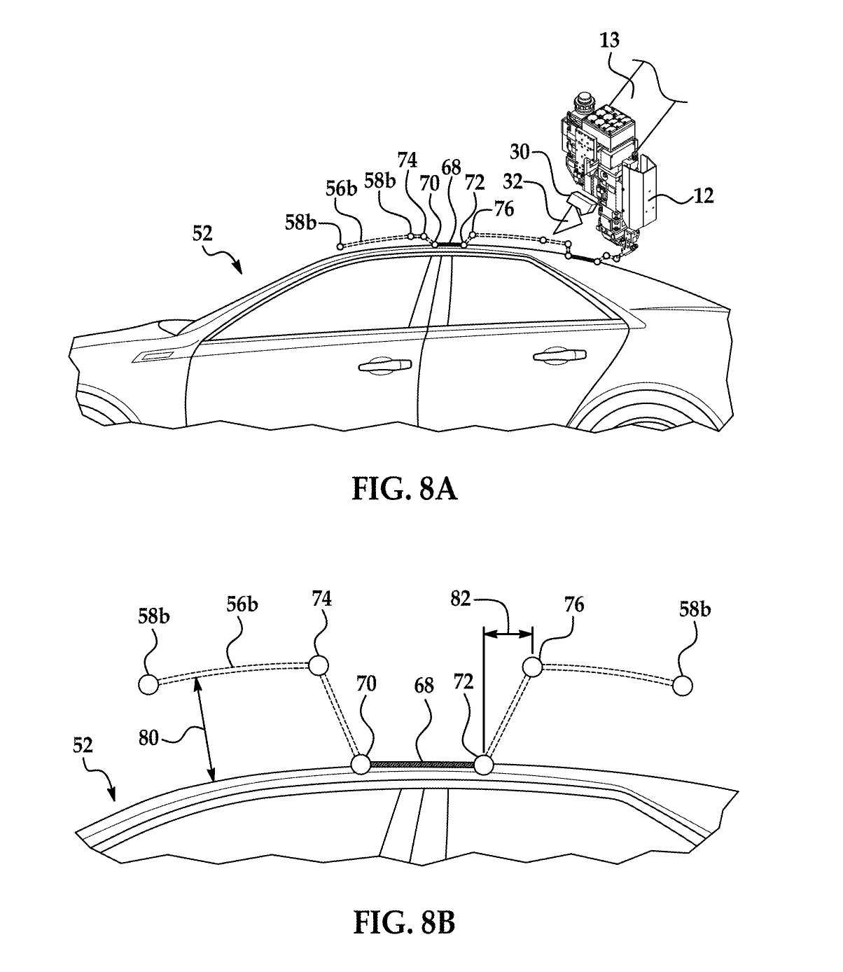

With reference also to FIGS. 7 and 8, in one example and application, the controller 100 can be configured to execute preprogrammed instructions for the robot 13 to move and guide the joining head 12 along a predetermined joining path 56, for example along a component joint 22 to be seam welded or brazed. For example, the memory 120 can include instructions to move the end effector 12 of the joining system 10 along joining path 56, with program positions 58 saved as positional guides. The controller 100 can also control the speed at which the joining system 10 moves along the joining path 56 and the feed rate at which fill material is dispensed from the feeder 14. In some examples, the controller 100 is configured to move the head 12 between program positions 58 based on a tool center point (TCP) 17. Thus, the controller 100 instructs a robot 13 to move the TCP 17 along the joining path 56. The TCP 17 can be located at the end of feeder 14 as shown in FIG. 1. Alternatively, other TCP locations known by those skilled in the art may be used.

Referring to FIG. 2, an example of exemplary welding/brazing head includes a sensor 30. The exemplary sensor 30 can be configured to measure, scan and/or detect certain physical characteristics of joint 22 within a sensing area 32. For example, the surface geometry or curvature of the joint 22 and qualities or characteristics of the filled joint 22 or the brazing or welding bead can be detected and/or measured. For example, the sensor 30 can detect a depth of the fill material of joint 22. It is further contemplated that the sensor 30 can detect a surface smoothness, width, and presence of a weld or brazing material within the joint 22. The sensor 30 can transmit a quality signal to the controller 100 that can include characteristic information of the joint 22. In alternate examples and configurations not shown, the sensor 30 can send the quality signal to a separate computing device or processor. The information and/or data collected by the sensor 30 can be used to evaluate the quality of the joint 22.

Examples of sensor 30 can include a sheet-of-light laser scanner and a 2D line scanner. The sensor 30 can include a laser diode and a CMOS detector configured to cast one or more lines of laser light across a target area and output data indicating the geometric features of an object in the target area. The sensor 30 can project a line of light transversely across the joint 22 at a point of measurement. The sensor 30 can be configured to detect a contour of the line of light which indicates surface geometry of the joint 22. An exemplary sensor 30 of this type is a GOCATOR sensor offered by LMI Technologies, Inc. Other sensor configurations can also be employed to accommodate the design and performance requirements of a particular application. While some embodiments are shown having one sensor 30, two or more sensors can also be used. Other sensors and detecting devices used to detect surface and geometric characteristics known by those skilled in the art may be used.

In the preferred example shown in FIG. 2, the sensor 30 is positioned downstream of laser 16 and can be operatively connected to the joining head 12 or the robot arm. The sensor 30 is positioned in fixed and predetermined distance relative to the feeder 14 and/or laser 16 and preprogrammed into the controller or system 10. In a preferred example, the sensor 30 can continuously inspect the joint 22 as the head 12 is moved along joint 22.

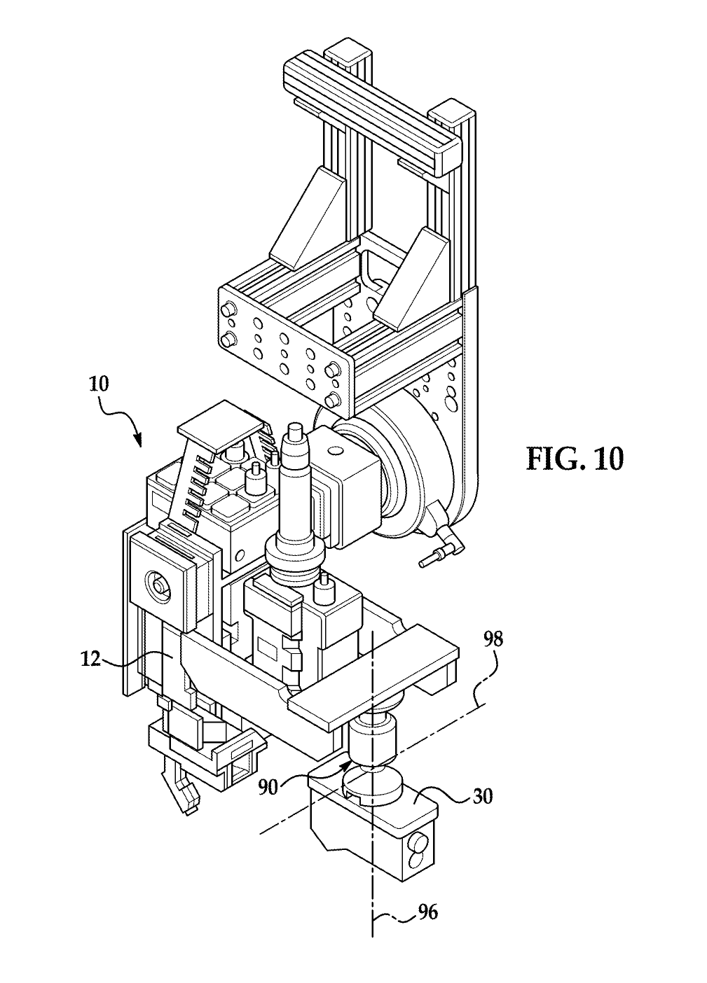

Referring to FIGS. 10 and 12, an example of an adjustable sensor 30 including a swivel 90 is illustrated. In the example shown, the swivel 90 includes end effector or filler head 12 attachment 92 connected to head 12 and sensor attachment 94 connected to the attachment 92 and sensor 30 as generally shown. In a preferred example sensor 30 is omni-directionally pivotable or rotatable relative to head 12 to adjust the position and field of vision or scan of sensor 30. For instance, swivel 90 can permit sensor 30 to be adjusted about axes 96 and 98. The swivel 90 can have any suitable configuration. Swivel 90 preferably includes a lock or securing attachment to securely lock of fix the position of the sensor 90. Although shown as a ball and socket, swivel 90 may include other two dimensional, three dimensional or omnidirectional devices, for example hinges, pins and other devices known by those skilled in the art. It is appreciated that the sensor 30 can be connected to head 12 in other ways to allow position and orientation adjustments of sensor 30 as described.

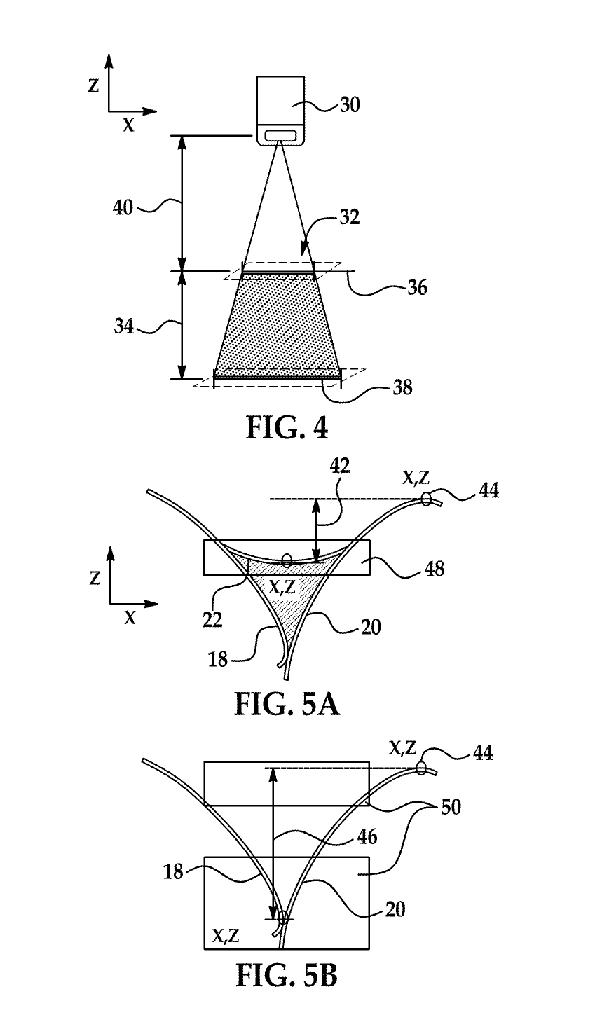

FIG. 4 illustrates one embodiment of a preferred sensor 30 with a sensing area 32. The sensing area 32 can include a measurement range 34 defined between a near field of view 36 and a far field of view 38. The measurement range 34 generally corresponds to the area in which the sensor 30 can detect surface distances and characteristics most accurately. The sensor 30 need not physically contact the joint 22 or the first or second workpieces 18 and 20 to detect characteristics of the joint 22. In a preferred example, the sensor 30 is spaced from the measurement range 34 by a “stand-off” distance 40. For example, the stand-off distance 40 can be approximately 90 mm. The sensor 30 can be connected to head 12 such that joint 22 is within the measurement range 34 for the most accurate measurements.

In a preferred example, the sensor 30 is calibrated after being connected to the welding/brazing/filler head 12. In one example of calibration, a sphere of known diameter is used to teach/identify the distance of a tool center point (TCP) 17 or other portions of the welding/brazing head 12 to the sensor 30. One method of calibration is the FANUC 6-point teaching method. Other methods of calibration known by those skilled in the art may be used.

FIGS. 5A and 5B schematically illustrate two examples of how system 10 may be used to monitor and determine whether the brazed joint 22 is acceptable or unacceptable using the sensor 30 and the controller 100. In one example of industry practice, the depth, that is, the top of the brazing or welding bead joint 22, relative to the top surface or plane of the material surface is a measure/indication of the quality of the welded/brazed joint. In other words, if the filler material in joint 22 does not fill the joint and reach a certain height, the proper amount of filler material may not be present for acceptable visual or structural performance standards.

In both FIGS. 5A and 5B, a cross section of an exemplary joint 22 between the first workpiece 18 and the second workpiece 20 is shown. The sensor 30 can be used to detect a depth 42 of joint 22. In the example, the depth 42 is a first linear distance from a work piece location 44 to the lowest point of the upper surface of the filled material in joint 22 as generally shown in FIG. 5A. The workpiece location 44 can be on either the first or second workpiece 18 and 20. If the measured depth 42 is greater than a predetermined value, in other words insufficient filler material is in this joint 22 location, than a fault or problem brazing area is detected.

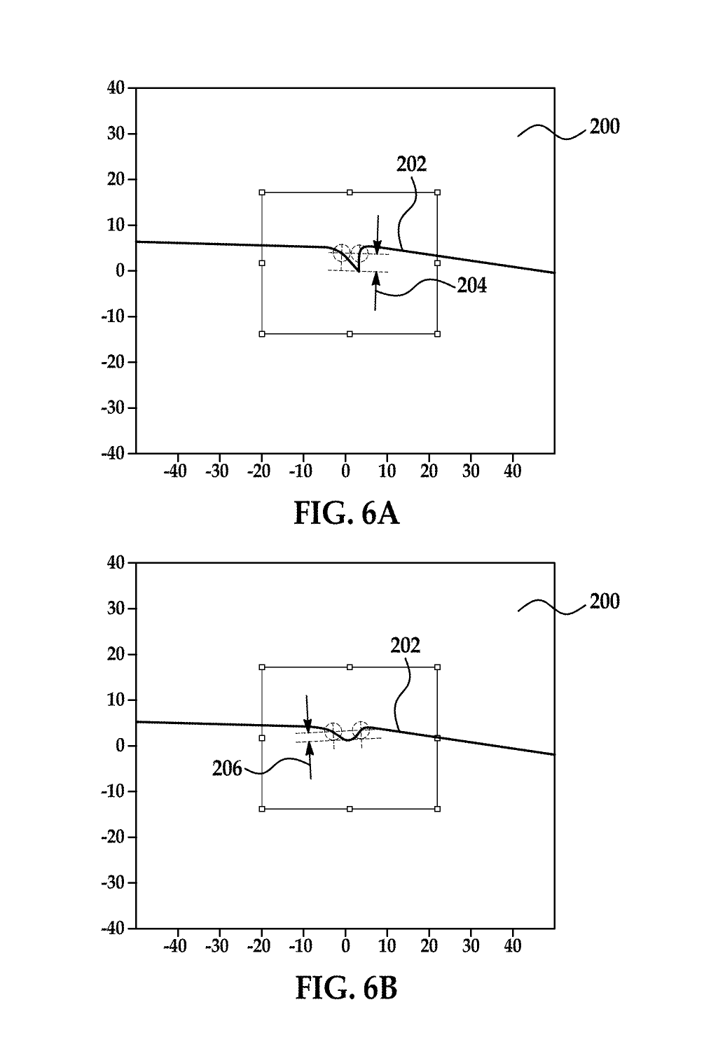

Referring to FIG. 5B, an example of a joint 22 without a braze or weld bead is shown. With exemplary sensor 30, a total and second depth 46, or second linear distance, of the joint can be detected. With the known second depth 46 of the unfilled joint 22, numerical ranges for an acceptable joint fill height range 48 (FIG. 5A) and unacceptable joint fill height range 50 may be measured, determined and preprogrammed into system 10 and/or controller 100. In a preferred process, acceptable 48 and unacceptable 50 ranges are determined prior to finalization of an assembly brazing process establishing an acceptable target or range 48. Once targets or acceptable 48 and unacceptable ranges 50 or values are established, sensor 30 can take depth measurements, for example depth 42, in real or almost real time during the production process and the controller can compare the measurement against the predetermined values to determine whether the joint is acceptable or unacceptable. As discussed further below, when it is detected that the filler material is outside of a target or acceptable range, system 10 identifies or flags the specific portion of the joint 22 as a fault or defective and begins recording/storing the position of the head 12 until the fault condition no longer exists, Since the distance between the sensor 30 and head 12 TCP has been calibrated and is known, an accurate positional reading of where the braze fault began and ended is recorded and usable for the system 10 to automatically revisit and repair or supplement the joint until the acceptable fill target or range is achieved. FIGS. 6A and 6B are examples of a graphical display 200 of a portion of a joint that can be generated from data collected by sensor 30, for example the GOCATOR sensor identified above. FIG. 6A is the joint without a brazing bead and 6B shows the joint with a brazing bead. The exemplary graphical display 200 depicts a joint measured at a particular or predetermined location along joining path 56 (see FIG. 7). In one example, the graphical display includes a workpiece image 202 and a joint depth 204 (shown and explained as 46 in FIG. 5B).

For example, In FIG. 6B, and as explained for FIG. 5A, the filled joint depth 204 is measured and determined whether the brazing bead meets the predetermined value or range for an acceptable braze. If determined to meet the acceptable target or range, the location is accordingly not flagged as being unacceptable. If the measured depth or height of the brazing bead falls outside of the predetermined value or range, the fault is immediately triggered, and the position of the head 12 is recorded and stored in memory for later retrieval to initiate an inspection and/or joint repair cycle.

In one or more arrangements, the joining system 10 can be operated in an automotive assembly or finishing line, and can be used to finish joints between two sheets of material along a vehicle's roof panel. For example, FIGS. 7, 8A, and 8B show joining system 10 used along a roof 54 of a vehicle 52. In an example application, the vehicle 52 can be transported to a brazing station through conveyors (not shown) that includes the joining system 10. The joining system 10 can operate to braze a specific portion of the vehicle 52 before the vehicle 52 is conveyed to a next station.

Referring to FIG. 7, the exemplary filling or brazing head 12 of the joining system 10 travels along a predetermined and preprogrammed path 56 to braze joint 22. In one example, predetermined positions of the path 56 may be identified to measure the brazing bead height for comparison against predetermined acceptable and unacceptable values as previously described. Alternately, the sensor 30 can continuously measure the brazing bead depth along the entire path 56. It is understood that various combinations of measurement points may be used depending on the application or performance and quality specifications. Ideally, the brazing or welding process will result in a joint 22 with a generally uniform depth and smoothness along the entire joining path 56. In practice, however, the brazing process can result, for example, in acceptable braze portions 60, and fault portions 62 as shown in FIG. 7. For instance, the fault portions 62 can correspond to those portions of joining path 56 that include a fault or gap in the brazing or welding bead. Portions of the joining path 56 can be unacceptable for a variety of reasons, such as a lack of filler material being deposited in such positions, improper depth of the fill material, or unacceptable smoothness of the fill material in the joint 22.

In one or more arrangements, the sensor 30 can be in communication with the controller 100 such that a quality signal can be sent to the controller 100. In some embodiments, the quality signal can be communicated in real-time as the sensor 30 detects physical characteristics of joint 22 within the sensing area 32. The quality signal can be communicated from the sensor 30 to the controller 100 or other computing device. In some embodiments, the sensor 30 can include memory capable of storing joint quality data and communicating the data subsequent to a welding or brazing operation. The sensor 30 can also include a sensor controller that interprets the quality of the joint 22 and communicates a quality signal to controller 100 at regular intervals or subsequent to the joining system 10 completing the joining path 56. The quality signal can include values indicative for each of an acceptable or unacceptable joint condition for each position along the joining path 56.

In the exemplary system 10 described, the location and/or geometric coordinate positions of fault portions 62 are recorded or “flagged” by the controller 100 and/or the sensor 30 and saved in a memory source. For example, with reference to FIG. 7, fault portions 62 are flagged, and include an unacceptable or fault start point 64 and unacceptable or fault end point 66. The system 10 and/or controller 100 can determine whether the joint 22 is unacceptable based on the signal received from the sensor 30 and a comparison to predetermined or target values as described above. If the joint 22 is determined to be unacceptable the controller can flag the location of the sensor 30 and/or the head 12 TCP. For example, the controller 100 can identify the three dimensional positional coordinates of the filler head 12 at fault start point 64 based on the signal sent from the sensor 30. As the head 12 moves along the joining path 56 (left to right as viewed from the perspective of FIGS. 7 and 8), the sensor 30 inspects the joint 22 and can detect an unacceptable value which identifies the fault start point 64. The fault end point 66 is similarly identified and recorded, which is the next position where joint 22 becomes acceptable. This data can be saved in memory 120 or external memory in communication with the controller 100, such that the locations of fault portions 62 may be retrieved for evaluation or initiation of an inspection or repair cycle by system 10.

The joining system 10 can be configured to efficiently repair fault portions 62, as illustrated, for example, in FIGS. 8A and 8B. With the known and accurate position of the fault portions 62 saved in system 10 memory, the exemplary controller 100 can determine and generate a repair movement path 56b that includes a repair path 68 of travel coinciding with the identified fault portion 62, to allow joining system 10 to “fill-in” or repair the fault portions 62. The repair movement path 56b can include several robot positions 58b set by the controller 100 to move head 12 to and from fault portions 62. FIGS. 8A and B illustrates an exemplary repair movement path 56b including repair path 68. The repair path 68 can have a repair start point 70 and a repair end point 72. The repair path 68 can correspond to the position of fault portion 62 (as shown in FIG. 7). The repair start point 70 can coincide with fault start point 64 (see FIG. 7). The repair path 68 can include only those areas that include fault portion 62. The repair re-brazing or re-welding can occur either immediately following the initial process or at a repair station at an alternative location within the facility. The sensor 30 can be used to monitor and measure the repair path 68 similar to that described above in the initial production pass/sequence. If any portions of repair path 68 are determined to be unacceptable, the repair process can be repeated, with a new repair joining path generated.

As shown in FIGS. 8A and 8B, in one example, the repair movement path 56b contains portions that are offset from the original joining path 56 (shown in FIG. 7) to avoid risk of contact between head 12 and the finished joint 22. Thus, the chance for damage to the vehicle 52, the joint 22, and the end effector 12 can be reduced or eliminated. For example, the offset portions of the repair movement path 56b can be spaced a distance 80 from the first and/or second workpiece.

With reference to FIG. 8B, where a repair path 56b includes an offset distance 80, path 56b can include pounce points 74, 76 proximate to fault/repair path 68 where the brazing filler tip is moved from the offset distance toward the joint and positioned for the repair brazing bead operation. As used herein, “pounce points” can include robot positions near a change in offset for repair path 68. For example, the joining system 10 can be operated from left to right in FIG. 8B. The system 10 generates a repair path 68 using the known fault start point 64 and fault end point 66. The system 10 can be moved from a repair robot position 58b to a first pounce point 74 or, alternately, moved directly to repair start point 70. If first moved to first pounce point 74, the head 12 of the joining system is then moved inward to repair start point 70. The head 12 moves along repair path 68 to repair end point 72 in a similar manner described above. Following completion of the repair path 68, head 12 may be moved second pounce point 76. In one example, pounce points 74, 76 can be offset a predetermined distance in a longitudinal direction from repair start point 70 or repair end point 72. For example, pounce point 76 can be positioned longitudinally offset from the repair end point 72 a distance 82. Head 12 may subsequently be moved to another identified fault area along joint 22 for further repair or return to a predetermined location for further production processing or repair processing. It is understood that other repair paths, points and sequences for repairing the joint 22 known by those skilled in the art may be used.

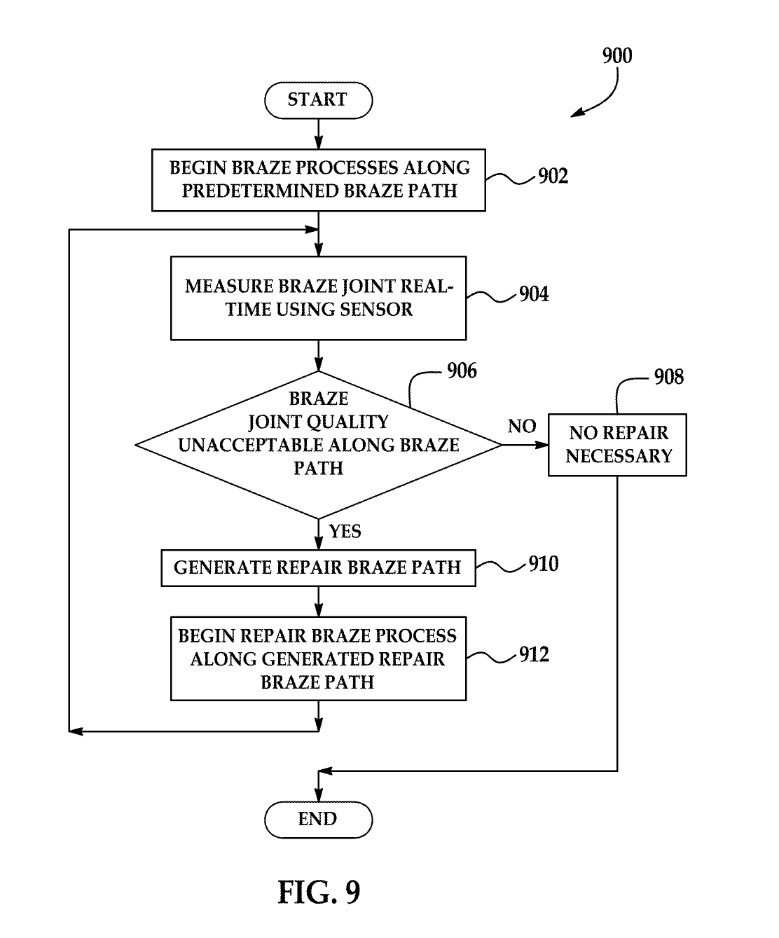

FIG. 9 illustrates an exemplary process 900 for inspecting a joint and performing repairs using joining system 10.

In a first preliminary step not illustrated, a braze, welding, joining or sealing path of travel is determined and preprogrammed to move the robot 13 or other conveying device supporting head 12 along the filling, for example joining or sealing, path of travel. In an optional process step not illustrated, the system 10 and sensor 30 is used to scan/measure a representative joint for which the brazing line and program was designed for. As described above, measurements, for example second depth 46 in FIG. 5B, may be taken to predetermine target braze bead depth or height values that are acceptable or unacceptable (or faults) for storage in system 10 memory and for future reference and comparison as generally described above.

In another optional process step not shown, on connection of the sensor 30 to the head 12 or robot, a calibration step is done to accurately determine the distance between the sensor 30, or sensor line or field of vision, and the head 12 TCP 17 or other predetermined point of head 12. As described, the distance between the sensor 30 and predetermined point of head 12 is used to specifically identify the coordinate location of the head 12 when a fault is detected and when the fault ends. Additional processes prior to beginning with the production brazing, seam welding or other joining processes known by those skilled in the art may be included in system 10 and process 900.

Beginning with step 902, the braze process is commenced along a predetermined joining path 56. In step 904, and as described above, an exemplary sensor 30 is used to scan and measure a predetermined characteristic of the applied bead, for example bead or fill depth or height. In one example as described above, the scan/measurement data is communicated to the controller or other system 10 device for comparison to the predetermined acceptable/unacceptable reference values or ranges.

In an exemplary step 906, a comparison of the measured preferred brazing bead characteristic and the predetermined reference and/or acceptable/unacceptable values is made in system 10 and a determination is made whether the measured bead at a location is acceptable or includes a defect or fault requiring further inspection and/or repair. If a fault is detected, the known position of the head 12 (through the known distance between the sensor 30 and the head 12 is calculated, identified, recorded and stored in system 10 memory. In one example, the identification and recording of the line or area of fault is continuously recorded until the fault or error condition is no longer detected by sensor 30.

If there was no fault portion or fault detected along the path 56, further inspection or repair is not necessary (step 908) and the brazing process is complete.

In one example, if a fault was detected, a repair joining path of travel is generated in step 910 by the controller 100 or other portion of system 10, which includes at least the starting and ending points 64 and 66 of the fault portion 62 along the joining path 56 determined in step 904. In step 912 a repair path process is started along the generated repair joining path. For example, repair movement path 56b can be determined, that includes repair robot positions 58b, pounce points 74, 76, and repair path 68. The repair path process is monitored by the sensor 30 and the process of determining quality is repeated until no fault portions of joining path exist.

Although described as occurring in a particular order, the steps in process 900 can be performed in different order and/or concurrently. Additionally, steps in accordance with this disclosure can occur with other steps not presented and described herein. Furthermore, not all illustrated steps can be required to implement a method in accordance with the disclosed subject matter. Other steps and in alternate orders of steps may be used as known by those skilled in the art. It is understood that the described process may be used in joining and or sealing operations, for example welding, brazing, adhesives sealants, priming and painting, and other applications known by those skilled in the art.

It will be appreciated that arrangements described herein can provide numerous benefits, including one or more of the benefits mentioned herein. For example, arrangements described herein can increase the reliability and efficiency of material joining processes in automated production. For example, joints can be monitored constantly and imperfections in the finished joint can be identified and the positions can be saved. Repair paths can be generated quickly with such data, allowing for automated repair. Such arrangements can eliminate or reduce the amount of time needed for manual inspection and repair.

The above-described aspects, examples, and implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method for filling a joint defined by a first workpiece and a second workpiece, the method comprising the steps of:
positioning a filling head in alignment with a joint defined by the first workpiece and the second workpiece;
selectively moving the filling head along a joint path of travel defined by the joint;
sequentially adding a joint filler material along the joint path of travel;
sequentially measuring a surface geometry of the filled joint while the filling head moves along the joint path of travel;
identifying at least one characteristic in the measured surface geometry; and
storing in memory a geometric coordinate position of the filling head along the joint path of travel on identification of the measured surface geometry characteristic.

2. The method of claim 1 wherein the at least one characteristic is a fault in the filled joint, the method further comprising the steps of:
identifying a starting point of the fault when the fault is first identified; and
identifying an ending point when the fault is no longer identified, the portion of the joint path of travel between the fault starting point and the fault ending point defining a repair path of travel.

3. The method of claim 2 wherein the step of storing in memory further comprises storing the first coordinate position of the filling head at the fault starting point and the fault ending point.

4. The method of claim 3 further comprising the step of generating a repair path of travel between the fault starting point and the fault ending point along the joint path of travel.

5. The method of claim 4 further comprising moving the filling head to the fault starting point; and
sequentially adding the filler material the joint along the repair path of travel.

6. The method of claim 4 wherein the repair path of travel further comprises an offset repair portion path of travel longitudinally distant from the repair path of travel along the path of travel and elevated above the first and the second workpieces.

7. The method of claim 2 wherein the step of measuring the surface geometry further comprises the steps of:
measuring a first linear distance between a predetermined point on one of the first or the second workpieces and an upper surface of the filled material in the joint at a point of measurement along the path of travel.

8. The method of claim 7 further comprising the step of comparing the measured first linear distance to stored predetermined values; and
determining whether the first linear distance is within a numerical range of acceptable distances.

9. The method of claim 7 wherein the step of measuring the first linear distance further comprises:
projecting a line of light transversely across the joint at the point of measurement; and
detecting a contour of the line of light, wherein the surface geometry is indicated by the contour.

10. The method of claim 8 wherein the numerical range of acceptable distances is determined by:
measuring a second linear distance between the predetermined point on one of the first or the second workpieces and a lower intersection of the first and the second workpieces at the point of measurement along the path of travel.

11. The method of claim 10 wherein measurement of the second linear distance occurs prior to adding filler material in the joint.

12. The method of claim 1 further comprising the steps of:
connecting a sensor to the filling head downstream of the filling head along the path of travel;
calculating the fixed distance between the sensor field of vision and a predetermined point on the filling head; and
calculating a geometric coordinate position of the filling head along the path of travel when the at least one characteristic is identified.

13. A filling device for use in a filling an automotive sheet metal joint, the device comprising:
a filling head having a filler material dispensing tip selectively positioned and movable along a workpiece filling path defined by a first workpiece and a second workpiece;
a sensor connected to the filling head at a predetermined distance from a predetermined point on the filling head, the sensor operable to detect at least one predetermined characteristic of fill material deposited in the workpiece filling path ; and
a controller in electronic communication with the filling head and the sensor, the controller having a memory and a processor, the memory further comprising::
preprogrammed executable instructions to measure a first distance between a predetermined point on one of first or the second workpieces and an upper surface of filler material in the filling path at a point of measurement on the filling path;
preprogrammed executable instructions to compare the measured first distance to predetermined values of a depth of the filler material in the filling path; and
preprogrammed executable instructions to calculate a geometric coordinate position of at least one of the filling head or the detected predetermined characteristic of fill material in the filling path.

14. The device of claim 13 further comprising a swivel bracket connected to the filling head and the sensor, the swivel bracket allowing omnidirectional movement of sensor relative to the filling head.

15. The device of claim 13, wherein the sensor further comprises:
a laser line generator operable to project a line of light transverse to a surface geometry of the workpiece filling path including an upper surface of filler material deposited in the filling path;
a receiver for receiving data from the projected line of light; and
a transmitter for transmitting the surface geometry of the workpiece filling path and upper surface of filler material to a controller for comparison to predetermined filler values.

16. The device of claim 15 further comprising preprogrammed executable instructions to generate a repair path of travel for the filling head along at least a portion of the filling path of travel.

17. The device of claim 16 wherein a portion of the repair path of travel is elevationally offset from the filling path of travel.

18. The device of claim 13 wherein the filling head is one of a brazing head or a seam welding head and the filling path of travel is a joining path of travel.
